(19) United States
(12) Patent Application Publication
(10) Pub. No.: US 2019/0197176 A1
(43) Pub. Date: Jun. 27, 2019

(54) IDENTIFYING RELATIONSHIPS BETWEEN ENTITIES USING MACHINE LEARNING

(71) Applicant: Microsoft Technology Licensing, LLC, Redmond, WA (US)

(72) Inventors: Xiaoqiang Luo, Cos Cob, CT (US); Yunpeng Xu, Millburn, NJ (US); Marcello Oliva, New York, NY (US)

(21) Appl. No.: 15/851,142

(22) Filed: Dec. 21, 2017

(51) Int. Cl. G06F 17/30; G06N 5/02; G06N 99/00; H04L 29/06

(52) U.S. Cl. CPC G06F 17/30598; H04L 63/102; G06N 99/005; G06N 5/022

(57) ABSTRACT

Techniques for identifying relationships between entities using machine learning are disclosed herein. In some embodiments, a computer-implemented method comprises: ingesting natural language text comprising a first target entity and a second target entity; identifying a relationship between the first target entity and the second target entity using at least one model; and performing a function using the identified relationship between the first target entity and the second target entity based on the identifying of the relationship, the function comprising a database modification operation or a relationship verification operation, the database modification operation comprising modifying at least one of a graph, a corresponding profile of the first target entity, and a corresponding profile of the second target entity stored in the database of the online service to indicate the identified relationship, and the relationship verification operation comprising causing the identified relationship to be displayed on a computing device.

### TECHNICAL FIELD

The present application relates generally to data security and verification and, in one specific example, to methods and systems of identifying relationships between entities in a database using machine learning.

### BACKGROUND

Some online services store records of entities in their databases. However, relationships that exist in the real world between entities are often not reflected in the database of an online service. This lack of relationship data causes technical problems for the online service, negatively affecting its performance of functions. For example, in situations where the online service is performing a function, such as a search, involving a first entity that has a relationship with a second entity, the lack of stored relationship data accessible to the online service causes the online service to omit the second entity from the performance of the function in situations where the second entity relevant and should be included. As a result, the accuracy and completeness of the performance of function are diminished. Additionally, since otherwise relevant results of the function are omitted or not generated, users of the online service often spend a longer time on using the online service for that function because they are not satisfied with the original results, thereby consuming electronic resources (e.g., network bandwidth, computational expense of server performing search). Other technical problems from such omissions can arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of a merge and match system, in accordance with an example embodiment.

FIG. 4 illustrates a graphical user interface (GUI) in which profile data of a profile of a user of an online service is displayed, in accordance with an example embodiment.

FIG. 5 illustrates a GUI in which natural language text is displayed, in accordance with an example embodiment.

FIG. 6 illustrates a GUI in which an identified relationship between a first entity and a second entity is displayed, in accordance with an example embodiment.

FIG. 7 is a flowchart illustrating a method of identifying relationships between entities in a database using machine learning, in accordance with an example embodiment.

FIG. 8 is a flowchart illustrating a method of training a first model and a second model, in accordance with an example embodiment.

FIG. 9 is a flowchart illustrating a method of performing a relationship verification operation, in accordance with an example embodiment.

FIG. 10 is a flowchart illustrating a method of performing a search via an online service, in accordance with an example embodiment.

FIG. 11 is a flowchart illustrating another method of performing a relationship verification operation, in accordance with an example embodiment.

FIG. 12 is a block diagram illustrating a mobile device, in accordance with some example embodiments.

FIG. 13 is a block diagram of an example computer system on which methodologies described herein may be executed, in accordance with an example embodiment.

### DETAILED DESCRIPTION

Example methods and systems of identifying relationships between entities in a database using machine learning are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. Some technical effects of the system and method of the present disclosure are to enable a computer system to identify relationships between entities in a database using machine learning. As a result, the computer system is able to perform the functions of an online service more completely and accurately, thereby minimizing excessive consumption of electronic resources (e.g., network bandwidth, computational expense of server performing search). Additionally, other technical effects will be apparent from this disclosure as well.

In some example embodiments, operations are performed by a computer system (or other machine) having a memory and at least one hardware processor, with the operations comprising: accessing corresponding profile data from each one of a plurality of profiles stored in a database of an online service; extracting a plurality of training entity pairs from the profile data of the plurality of profiles based on a matching of at least one regular expression with the profile data, each one of the plurality of training entity pairs comprising a first training entity and a second training entity; training at least one model using the plurality of training entity pairs as training data; ingesting natural language text comprising a first target entity and a second target entity; identifying a relationship between the first target entity and the second target entity using the at least one model; and performing a function using the identified relationship between the first target entity and the second target entity based on the identifying of the relationship.

In some example embodiments, the function comprises a database modification operation or a relationship verification operation. In some example embodiments, the database modification operation comprises modifying at least one of a graph, a corresponding profile of the first target entity, and a corresponding profile of the second target entity stored in the database of the online service to indicate the identified relationship. In some example embodiments, the relationship verification operation comprises causing the identified relationship to be displayed on a computing device.

In some example embodiments, the at least one model comprises a first model and a second model, and the training of the at least one model comprises: training the first model to generate a probability that there is a relationship between two given entities; and training the second model to generate a probability that the relationship comprises a particular type of relationship between the two given entities.

In some example embodiments, the training of the at least one model comprises training the at least one model using the plurality off training entity pairs and other natural language text.

In some example embodiments, the identifying the relationship between the first target entity and the second target entity comprises generating a probability that the identified relationship exists between the first target entity and the second target entity. In some example embodiments, the performing the function comprises performing the database modification operation based on a determination that the probability exceeds a predetermined threshold value. In some example embodiments, the performing the function comprises performing the relationship verification operation, with the relationship verification operation further comprising causing the probability to be displayed on the computing device in association with the identified relationship.

In some example embodiments, the at least one model comprises at least one logistic regression model. In some example embodiments, the at least one model comprises at least one binary classification model. It is contemplated that the use of other types of models and classifiers are also within the scope of the present disclosure.

In some example embodiments, the natural language text is ingested from target profile data of a target profile stored in the database of the online service. In some example embodiment, the natural language text is ingested from a work experience field of the target profile data. In some example embodiments, the natural language text is ingested from an article or blog post published online.

In some example embodiments, the identifying of the relationship comprises identifying a direction of the relationship, the direction indicating a hierarchy among the first target entity and the second target entity. In other example embodiments, the direction of the relationship does not indicate a hierarchy.

In some example embodiments, the performing the function comprises performing the database modification operation in response to the identifying of the relationship.

In some example embodiments, the performing the function comprises performing the relationship verification operation, with the relationship verification operation further comprising: causing a prompting content to be displayed on the computing device in association with the identified relationship, the prompting content requesting that a user of the computing device verify the identified relationship; receiving a user input from the computing device, the user input indicating that the identified relationship is correct; and performing the database modification operation based on the user input indicating that the identified relationship is correct.

In some example embodiments, the operations further comprise: receiving a search query comprising the first target entity from a computing device; expanding the search query to include the second target entity based on the database modification operation; performing a search of the database of the online service using the expanded search query; generating search results based on the performing of the search using the expanded search query; and causing the search results to be displayed on the computing device.

In some example embodiments, the performing the function comprises performing the relationship verification operation, the relationship verification operation further comprising: causing a prompting content to be displayed on the computing device in association with the identified relationship, the prompting content requesting that a user of the computing device verify the identified relationship; receiving a user input from the computing device, the user input indicating that the identified relationship is incorrect; and using the identified relationship between the first target entity and the second target entity and the natural language text as feedback training data to train the at least one model, the feedback training data being tagged as an example of an incorrectly identified relationship.

In some example embodiments, the first training entity, the second training entity, the first target entity, and the second target entity each comprise a corresponding organization.

In some example embodiments, each one of the plurality of training entity pairs is extracted from a corresponding work experience field of the corresponding profile data.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

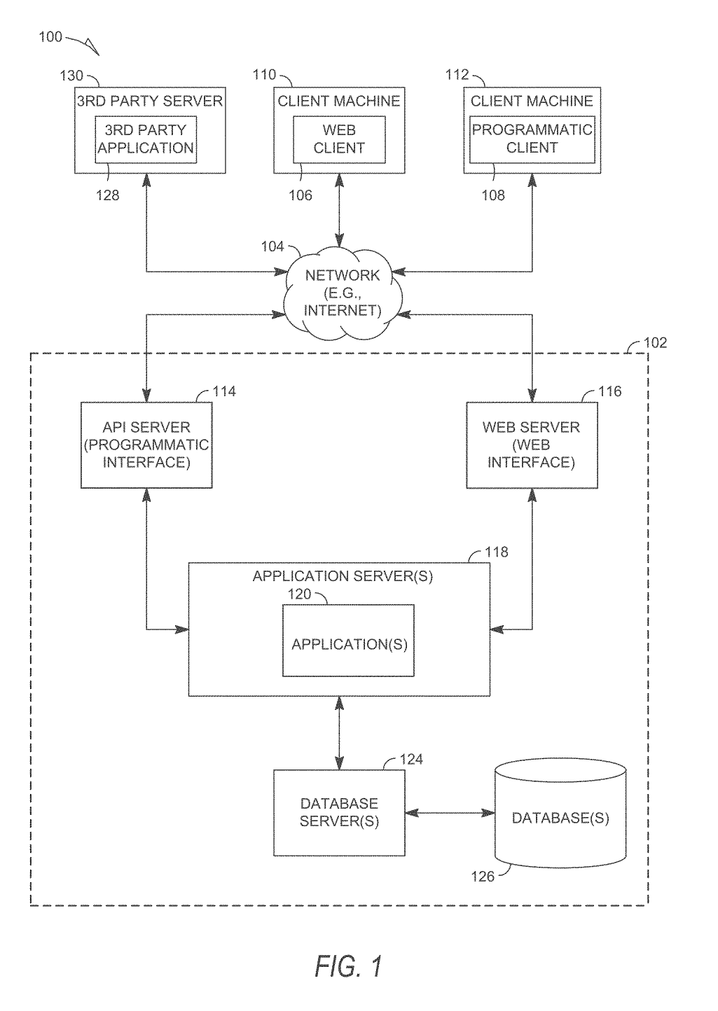

FIG. 1 is a block diagram illustrating a client-server system 100, in accordance with an example embodiment. A networked system 102 provides server-side functionality via a network 104 (e.g., the Internet or Wide Area Network (WAN) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

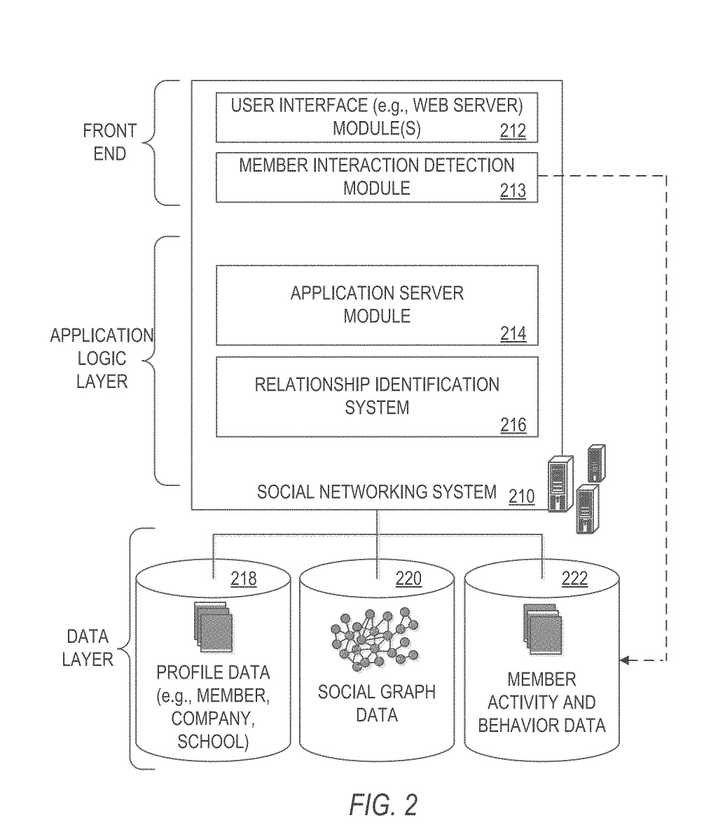

In some embodiments, the networked system 102 may comprise functional components of a social networking service. FIG. 2 is a block diagram showing the functional components of a social networking system 210, including a data processing module referred to herein as a relationship identification system 216, for use in social networking system 210, consistent with some embodiments of the present disclosure. In some embodiments, the relationship identification system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data laver. With some embodiments, individual application server modules 214 are used to implement the functionality associated with various applications and/or services provided by the social networking service. In some example embodiments, the application logic layer includes the relationship identification system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, borne town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members interactions and behavior (e.g., content viewed, links or buttons selected, messages responded to, etc.) may be tracked and information concerning the member's activities and behavior may be logged or stored, for example, as indicated in FIG. 2 by the database 222.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the relationship identification system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

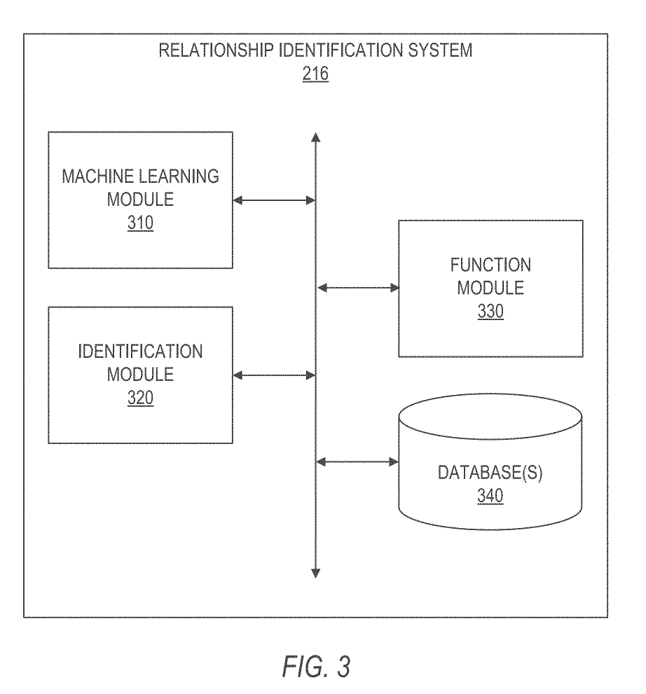

FIG. 3 is a block diagram illustrating components of the relationship identification system 216, in accordance with an example embodiment. In some embodiments, the relationship identification system 216 comprises any combination of one or more of a machine learning module 310, an identification module 320, a function module 330, and one or more database(s) 340. The modules 310, 320, and 330 and the database(s) 340 can reside on a computer system, or other machine, having a memory and at least one processor (not shown). In some embodiments, the modules 310, 320, and 330 and the database(s) 340 can be incorporated into the application server(s) 118 in FIG. 1. In some example embodiments, the database(s) 340 is incorporated into database(s) 126 in FIG. 1 and can include any combination of one or more of databases 218, 220, and 222 in FIG. 2. However, it is contemplated that other configurations of the modules 310, 320, and 330, as well as the database(s) 340, are also within the scope of the present disclosure.

In some example embodiments, one or more of the modules 310, 320, and 330 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the modules 310, 320, and 330 is configured to receive user input. For example, one or more of the modules 310, 320, and 330 can present one or more GUI elements (e.g., drop-down menu, selectable buttons, text field) with which a user can submit input.

In some example embodiments, one or more of the modules 310 and 320 is configured to perform various communication functions to facilitate the functionality described herein, such as by communicating with the social networking system 210 via the network 104 using a wired or wireless connection. Any combination of one or more of the modules 310, 320, and 330 may also provide various web services or functions, such as retrieving information from the third party servers 130 and the social networking system 210. Information retrieved by the any of the modules 310, 320, and 330 may include profile data corresponding to users and members of the social networking service of the social networking system 210.

Additionally, any combination of one or more of the modules 310, 320, and 330 can provide various data functionality, such as exchanging information with database(s) 340 or servers. For example, any of the modules 310, 320, and 330 can access member profiles that include profile data from the database(s) 340, as well as extract attributes and/or characteristics from the profile data of member profiles. Furthermore, the one or more of the modules 310, 320, and 330 can access profile data, social graph data, and member activity and behavior data from database(s) 340, as well as exchange information with third party servers 130, client machines 110, 112, and other sources of information.

In some example embodiments, the relationship identification system 216 is configured to train one or more models to identify relationships between entities using machine learning, and to use the trained model(s) to identify a relationship between entities. The relationship identification system 216 may then update a database of an online service to include an indication of the identified relationship between the entities, or display the identified relationship to a user for verification. In some example embodiments, the entities comprise companies or organizations. However, it is contemplated that other types of entities are also within the scope of the present disclosure. Although the examples discussed herein describe the determination and identification of a relationship between two entities, in some example embodiments, the features of present disclosure are extended to embodiments in which the relationship identification system 216 determines and identifies a relationship between more than two entities.

In some example embodiments, the machine learning module 310 is configured to access corresponding profile data from each one of a plurality of profiles stored in a database of an online service. For example, the machine learning module 310 may access profile data of profiles stored in the database 218 of social networking system 210 in FIG. 2. In this respect, the online service may comprise a social networking service. However, it is contemplated that other types of online service are also within the scope of the present disclosure.

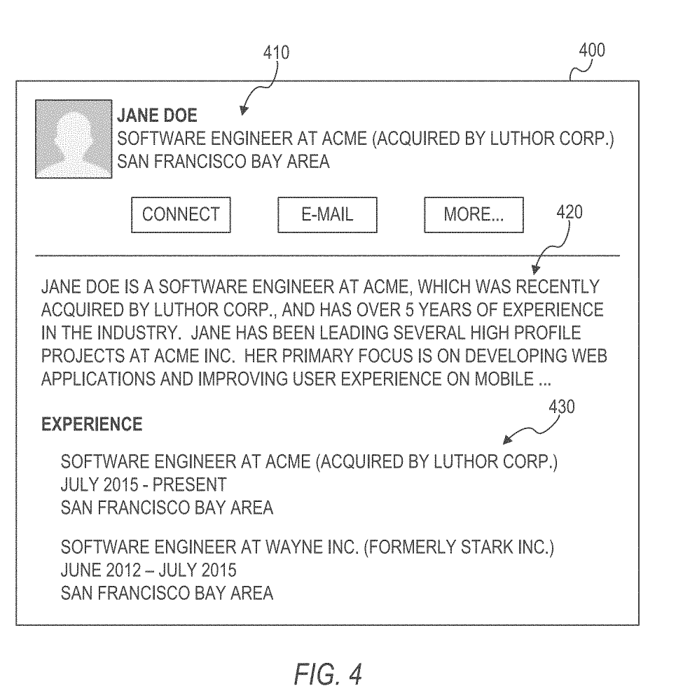

FIG. 4 illustrates a graphical user interface (GUI) 400 in which profile data of a profile of a user of an online service is displayed, in accordance with an example embodiment. The profile data in FIG. 4 may be displayed on a profile page of the user and stored in corresponding fields for the profile in the database(s) of the online service. In FIG. 4, the profile data being displayed comprises heading data 410 (e.g., name of user, current job title/position, current company/organization, geographic location), summary data 420 (e.g., a brief description of the user), and experience data 430 (e.g., a history of different work positions held by the user). In some example embodiments, each profile stored in the database(s) of the online service comprises a work experiences section, where the user to which the profile belongs may enter a position title, an organization for which the user worked, the duration of the employment, and other related information.

A user may be enabled to enter free text when editing his or her profile, and the user may enter more information for a particular field than required for the particular field. For example, the user may enter information indicating a relationship between two companies (or other entities). In FIG. 4, the profile data includes information about relationships between entities. For example, the heading data 410 comprises text (“ACME (ACQUIRED BY LUTHER CORP.)”) indicating an acquisition relationship between “ACME” and “LUTHER CORP.,” the summary data 420 comprises text (“ACME, WHICH WAS RECENTLY ACQUIRED BY LUTHOR CORP”) indicating an acquisition relationship between “ACME” and “LUTHER CORP.,” and the experience data 430 comprises text (“ACME (ACQUIRED BY LUTHER CORP.)”) indicating an acquisition relationship between “ACME” and “LUTHER CORP.” and text (“WAYNE (FORMERLY STARK INC.)”) indicating an transformation relationship between “WAYNE INC.” and “STARK INC.”

In some example embodiments, the machine learning module 310 is configured to extract a training entity pair from the profile data of the profile based on a matching of a regular expression with the profile data. The training entity pair comprises a first training entity and a second training entity, which may be used as training data in training one or more models to identify relationships between entities. In some example embodiments, the training entity pair is extracted from a work experience field of the profile. However, it is contemplated that the training entity pair may be extracted from other fields of the profile as well.

In some example embodiments, one or more patterns, such as “<CompanyA> (<predicate><CompanyB><Date>?)” are encoded as regular expressions, which are then matched to corresponding profile data of a plurality of profiles of users of the online service to identify instances of relationships. For example, the regular expressions may be matched to text segments in the work experience fields of profiles, such as “ACME (ACQUIRED BY LUTHER CORP.),” and then the matched text segments from the profile data may be converted into relationship instances to be used in training one or more models.

In some example embodiments, the machine learning module 310 is configured to train at least one model using a plurality of training entity pairs as training data Examples of models that may be used include, but are not limited to, a logistic regression model and a binary classification model. Other models may alternatively or additionally be used.

In some example embodiments, the training of the model(s) comprises training the model(s) using the plurality of training entity pairs and natural language text. Natural language comprises any language that has evolved naturally in humans through use and repetition without conscious planning or premeditation. Natural language is distinguished from constructed and formal languages, such as those used to program computers. In some example embodiments, the machine learning module 310 uses natural language text from news articles, blog posts, or other sources of information that may contain text describing relationships between entities, such as those discussing or reporting mergers and acquisitions and other relationships between companies and organizations.

Each training entity pair may be aligned with corresponding natural language text to be fed into the machine learning process of machine learning module 310 as training data for training the model(s). For example, a training entity pair comprising company A and company B may be input as training data with natural language text (e.g., segments of news articles and blog posts) that includes company A and company B. Each grouping of a training entity pair and corresponding natural language text segments may be lagged or labeled with the appropriate relationship between the two entities in the pair (e.g., no relationship, merger, acquisition, etc.) for the model(s) to learn on.

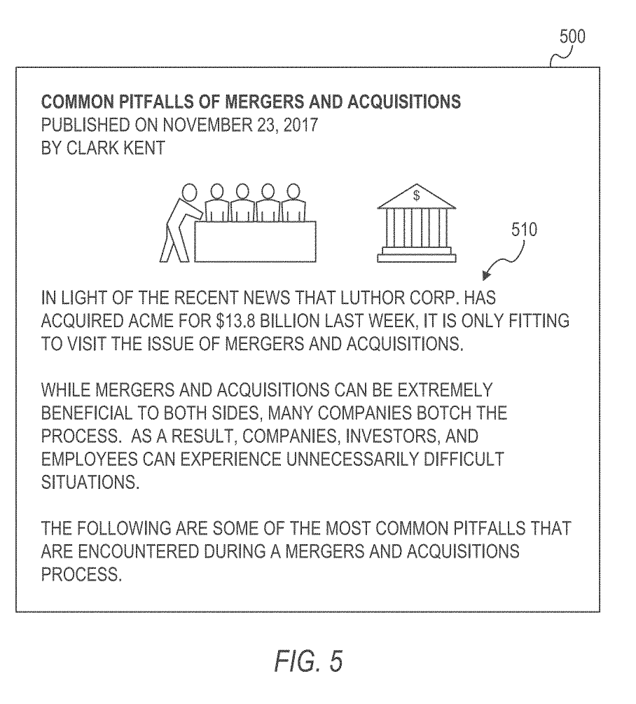

FIG. 5 illustrates a GUI 500 in which natural language text 510 is displayed, in accordance with an example embodiment. As seen in FIG. 5, the natural language text 510 may include text segments, such as a sentence, that include the two entities of a training entity pair. For example, the natural language text 510 comprises a text segment that discusses two entities, “LUTHOR CORP.” and “ACME.” as well as a relationship event between the two entities “LUTHER CORP HAS ACQUIRED ACME.” The training entity pair may be aligned with the natural language text segment, which may be tagged or labelled as an example of natural language text describing a relationship, and the training entity pair and the natural language text segment may be used as training data by the machine learning module 310 to train the model(s).

In some example embodiments, the model(s) comprise a first model and a second model, and the machine learning module 310 is configured to train the first model to determine whether there is a relationship between two given entities, and to train the second model to determine what type of relationship exists between two given entities. The determinations generated by the models may comprise probabilities that the corresponding event or condition exists. For example, in some example embodiments, the machine learning module 310 is configured to train the first model to generate a probability that there is a relationship between two given entities, and to train the second model to generate a probability that a relationship comprises a particular type of relationship between two given entities.

In some example embodiments, the identification module 320 is configured to ingest natural language text. The natural language text may comprise a first target entity and a second target entity. In some example embodiments, the natural language text is ingested from target profile data of a target profile stored in the database of the online service. For example, text entered by a user in creating or editing a profile of the user, such as the heading data 410, the summary data 420, or the experience data 430 in FIG. 4, may be ingested as natural language text to be used by the identification module 320. In some example embodiments, the natural language text is ingested from an article or blog post published online, such as the natural language text 510 in FIG. 5.

In some example embodiments, the identification module 320 is configured to identify a relationship, or determine that there is a relationship, between a first target entity and a second target entity using the model(s), and to a direction or type of the relationship. For example, the direction or type of the relationship may comprise or indicate a hierarchy among the first target entity and the second target entity, such as a parent and child/subsidiary relationship in the context of an acquisition relationship, where the parent is the entity that acquired the other company, which is the child/subsidiary. In other example embodiments, the direction of the relationship does not indicate a hierarchy, such as in a situation where entity A merges with entity B or entity A invests in entity B.

In some example embodiments, the identification module 320 generates one or more probabilities based on the model(s). For example, the identification module 320 may generate a probability that there is a relationship between two given entities based on a first model, and generate a probability that a relationship comprises a particular type of relationship between two given entities (e.g., company A acquired company B) based on a second model. The probabilities may comprise any value or measure that indicates a likelihood of an event, such as a percentage or a number between 0 and 1, where 0 indicates impossibility of the event and 1 indicates certainty of the event. It is contemplated that other forms of probabilities may also be used.

In some example embodiments, the function module 330 is configured to perform a function using the identified relationship between the first target entity and the second target entity in response to, or otherwise based on, the identifying of the relationship by the identification module 320. In some example embodiments, the function comprises a database modification operation or a relationship verification operation.

In some example embodiments, the database modification operation comprises modifying one or more records in the database(s) of the online service. For example, the database modification operation may comprise modifying at least one of a graph, a corresponding profile of the first target entity, and a corresponding profile of the second target entity stored in the database of the online service to indicate the identified relationship.

A graph comprises a collection of vertices or nodes and edges that join pairs of vertices. Each vertex or node may comprise an entity, and each edges may represent or correspond to a relationship or association between the two vertices or nodes that it connects. In some example embodiments, the graph comprises a social graph, such as the social graph previously described with respect to database 220 in FIG. 2, in which various associations and relationships that user of a social networking service establish with other members, or with other entities and objects, are stored and maintained. In some example embodiments, the graph comprises an economic graph, which may comprise a digital representation or mapping of the global economy, including a profile for members of the global workforce, enabling them to represent their professional identity and subsequently find and realize their most valuable opportunities. The economic graph may also include profile for companies, such as a profile for every company in the world. The economic graph may digitally represent every economic opportunity offered by those companies, full-time, temporary, and volunteer, and every skill required to obtain these opportunities. The economic graph may include a digital presence for every higher education organization in the world that can help users of the online service obtain these skills. Through mapping every user of the online service, company, job, and school, the online service is able to spot trends like talent migration, hiring rates, and in-demand skills by region, and provide the most complete and accurate data representation of real world relationships and associations for use in performing functions of the online service.

In some example embodiments, modifying a graph comprises connecting a node representing the first entity and a node representing the second entity with an edge that represents the identified relationship between the first entity and the second entity. In some example embodiments, the nature, type, direction, or hierarchy of the relationship is also represented by the edge connecting the first entity and the second entity.

In some example embodiment, the function module 330 is configured to perform the database modification operation in response to, or otherwise based on, a determination that one or more probabilities generated by the identification module 320 exceeds a predetermined threshold value. In one example, using a predetermined threshold value of 95%, the function module 330 does not perform the database operation for an identified relationship between company A and company B having a corresponding probability of 73%, but does perform the database operation for an identified relationship between company A and company C having a corresponding probability of 97%. By using this predetermined threshold value as a criteria or condition for performing the database modification operation, the function module 330 maximizes the accuracy of the data stored in the database, and therefore maximizes the accuracy of any functions of the online service that use the data stored in the database.

In some example embodiments, the relationship verification operation comprises causing the identified relationship to be displayed on a computing device of a user, such as an administrator of the online service tasked with verifying the accuracy of the identified relationship between the two entities. In some example embodiments, the function module 330 is configured to cause one or more of the probabilities generated by the identification module to be displayed on the computing device in association with the identified relationship.

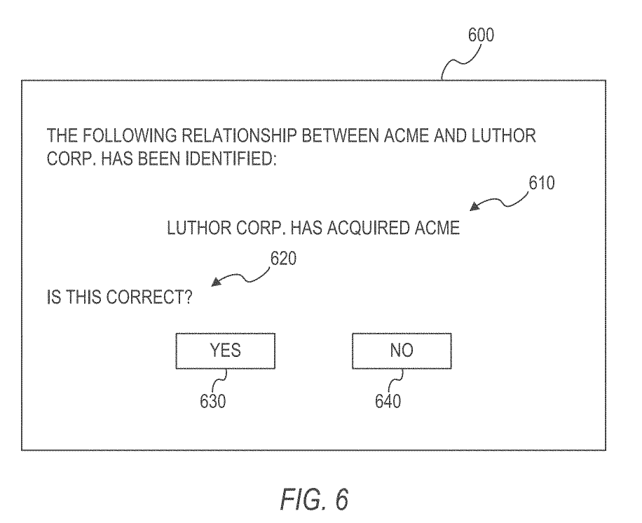

In some example embodiments, the function module 330 is configured to cause a prompting content to be displayed on the computing device in association with the identified relationship. The prompting content requests that a user of the computing device verify the identified relationship. FIG. 6 illustrates a GUI 600 in which an identified relationship 610 between a first entity and a second entity (“LUTER CORP. HAS ACQUIRED ACME”) is displayed, in accordance with an example embodiment. In FIG. 6, a prompting content 620 is displayed in association (e.g., concurrently, such as on the same page or view) with the identified relationship 610. The prompting content 620 requests that the user verify the identified relationship (“IS THIS CORRECT?”). In some example embodiments, one or more selectable user interface elements are configured to enable the user to submit user input to the relationship identification system 216 indicating whether the identified relationship 610 is correct or incorrect. For example, in FIG. 6, a selectable user interface element 630 (e.g., a selectable “YES” button) is configured to cause a signal to be transmitted to the relationship identification module 216 that the identified relationship 610 is correct, and a selectable user interface element 640 (e.g., a selectable “NO” button) is configured to cause a signal to be transmitted to the relationship identification module 216 that the identified relationship 610 is incorrect. It is contemplated that other ways of obtaining user verification input is also within the scope of the present disclosure.

In some example embodiments, the function module 330 is configured to receive a user input from the computing device, and perform the database modification operation in response to, or otherwise based on, the user input indicating that the identified relationship is correct. In some example embodiments, the function module 330 is configured to, in response to or otherwise based on the user input indicating that the identified relationship is incorrect, use the identified relationship between the first target entity and the second target entity and the natural language text as feedback training data to train the model(s), with the feedback training data being tagged as an example of an incorrectly identified relationship.

In some example embodiment, the function module 330 is configured to perform a search in response to a search query submitted by a user. For example, the function module 330 may be used by a recruiter to find users of the online service that are working for entity A, which has recently acquired entity B. The function module 330 may receive a search query comprising entity A from a computing device of the recruiter, and expand the search query to include the company B based on a previously performed database modification operation that updated the database of the online service to include the acquisition relationship between entity A and entity B. The function module 330 may then perform a search of the database of the online service using the expanded search query that includes both entity A and entity B, generate search results based on the search, and cause the search results to be displayed on the computing device of the recruiter. As a result of the database modification operation to modify the database to include the acquisition relationship between entity A and entity B based on the identification of the relationship by the identification module 320, the search results generated and provided to the recruiter are more accurate and complete. In some example embodiments, the function module 330 is configured to perform other functions using the modifications of the database that were performed as part of the database modification operation, such as determining the number of employees of a company. It is contemplated that the modifications of the database that were performed as part of the database modification operation may be used in the performance of other functions of the online service as well.

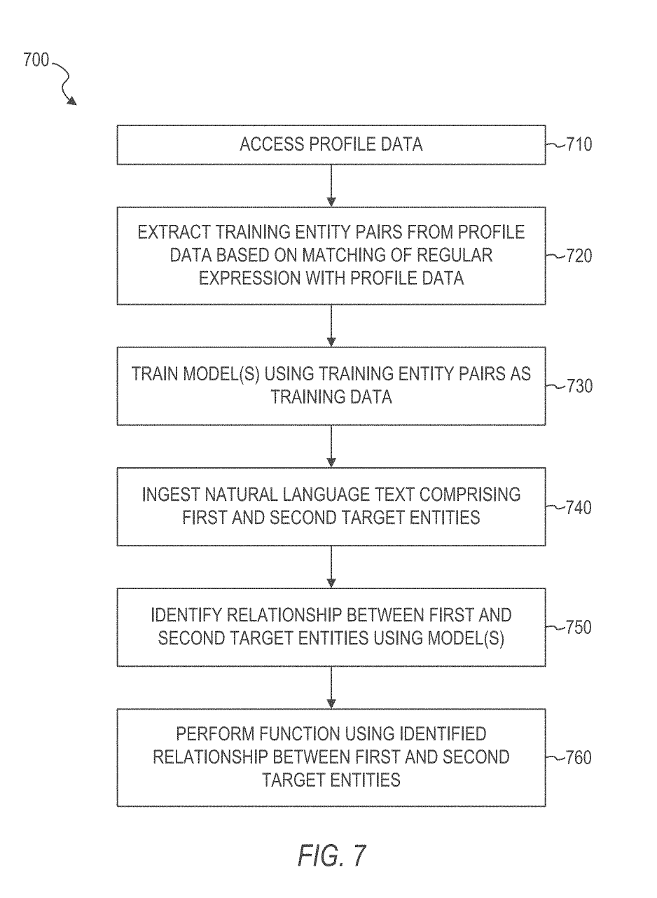

FIG. 7 is a flowchart illustrating a method of identifying relationships between entities in a database using machine learning, in accordance with an example embodiment. The method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the relationship identification system 216 of FIGS. 2-3, or any combination of one or more of its modules, as described above.

At operation 710, the relationship identification system 216 accesses corresponding profile data from each one of a plurality of profiles stored in a database of an online service.

At operation 720, relationship identification system 216 extracts a plurality of training entity pairs from the profile data of the plurality of profiles based on a matching of at least one regular expression with the profile data. In some example embodiments, each one of the plurality of training entity pairs comprises a first training entity and a second training entity. In some example embodiments, each one of the plurality of training entity pairs is extracted from a corresponding work experience field of the corresponding profile data from which the training entity pair is extracted.

At operation 730, relationship identification system 216 trains at least one model using the plurality of training entity pairs as training data. In some example embodiments, the training of the model(s) comprises training the model(s) using the plurality of training entity pairs and natural language text. In some example embodiments, the model(s) comprises at least one logistic regression model. In some example embodiments, the model(s) comprises at least one binary classification model. It is contemplated that the use of other types of models and classifiers are also within the scope of the present disclosure.

At operation 740, relationship identification system 216 ingests natural language text comprising a first target entity and a second target entity. In some example embodiments, the natural language text is ingested from target profile data of a target profile stored in the database of the online service. In some example embodiments, the natural language text is ingested from a work experience field of the target profile data. In some example embodiments, the natural language text is ingested from an article or blog post published online.

At operation 750, relationship identification system 216 identifies a relationship between the first target entity and the second target entity using the model(s). In some example embodiments, the identifying of the relationship between the first target entity and the second target entity comprises generating a probability that the identified relationship exists between the first target entity and the second target entity. In some example embodiments, the identifying of the relationship comprises identifying a direction of the relationship, with the direction indicating a hierarchy among the first target entity and the second target entity.

At operation 760, relationship identification system 216 performs a function using the identified relationship between the first target entity and the second target entity based on the identifying of the relationship. In some example embodiments, the performing the function comprises performing the database modification operation in response to the identifying of the relationship. In some example embodiments, the function comprises a database modification operation or a relationship verification operation. In some example embodiment, the performing the function comprises performing the database modification operation based on a determination that the probability exceeds a predetermined threshold value. In some example embodiments, the database modification operation comprises modifying at least one of a graph, a corresponding profile of the first target entity, and a corresponding profile of the second target entity stored in the database of the online service to indicate the identified relationship. In some example embodiments, the relationship verification operation comprises causing the identified relationship to be displayed on a computing device. In some example embodiment, the relationship verification operation further comprises causing the probability to be displayed on the computing device in association with the identified relationship.

It is contemplated that any of the other features described within the present disclosure can be incorporated into the method 700.

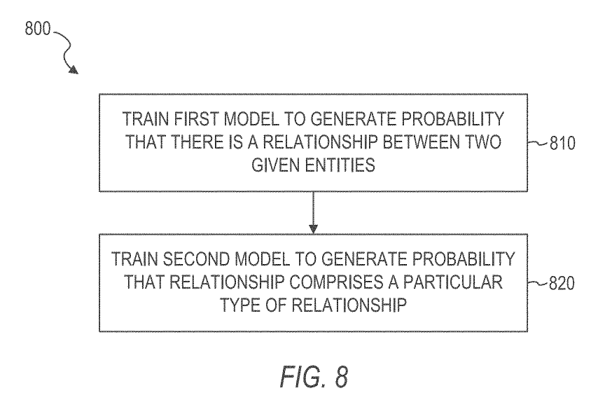

FIG. 8 is a flowchart illustrating, a method of training a first model and a second model, in accordance with an example embodiment. The method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the relationship identification system 216 of FIGS. 2-3, or any combination of one or more of its modules, as described above.

At operation 810, the relationship identification system 216 trains a first model to generate a probability that there is a relationship between two given entities. At operation 820, the relationship identification system 216 trains the second model to generate a probability that the relationship comprises a particular type of relationship between the two given entities.

It is contemplated that any of the other features described within the present disclosure can be incorporated into the method 800.

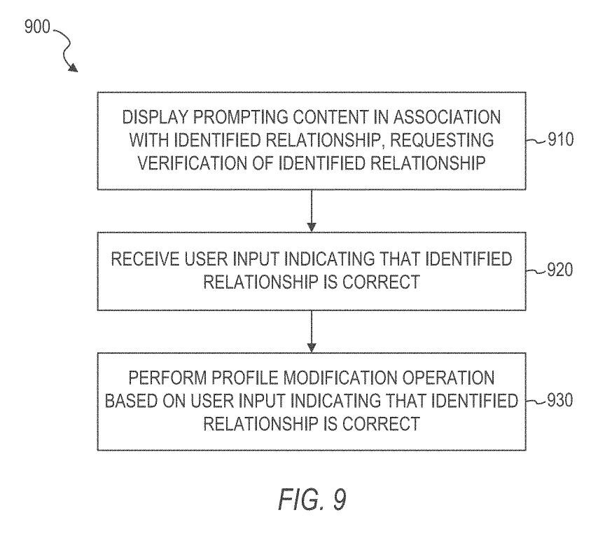

FIG. 9 is a flowchart illustrating a method of performing a relationship verification operation, in accordance with an example embodiment. The method 900 can be performed by processing logic that can comprise hardware (e.g., circuitry, dedicated logic, programmable logic, microcode, etc.), software (e.g., instructions run on a processing device), or a combination thereof In one implementation, the method 900 is performed by the relationship identification system 216 of FIGS. 2-3, or any combination of one or more of its modules, as described above.

At operation 910, the relationship identification system 216 causes a prompting content to be displayed on the computing device in association with the identified relationship. In some example embodiments, the prompting content comprises a request that a user of the computing device verify the identified relationship. At operation 920, the relationship identification system 216 receives a user input from the computing device. In some example embodiments, the user input indicates that the identified relationship is correct. At operation 930, the relationship identification system 216 performs the database modification operation based on the user input indicating that the identified relationship is correct.

It is contemplated that any of the other features described within the present disclosure can be incorporated into the method 900.

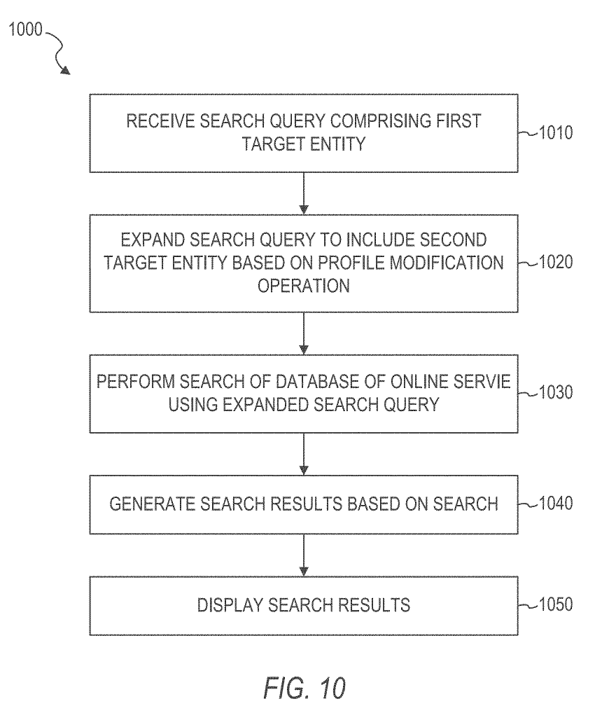

FIG. 10 is a flowchart illustrating a method of performing a search via an online service, in accordance with an example embodiment. The method 1000 can be performed by processing logic that can comprise hardware (e.g., circuitry, dedicated logic, programmable logic, microcode, etc.), software (e.g., instructions run on a processing device), or a combination thereof. In one implementation, the method 1000 is performed by the relationship identification system 216 of FIGS. 2-3, or any combination of one or more of its modules, as described above.

At operation 1010, the relationship identification system 216 receives a search query comprising the first target entity from a computing device. At operation 1020, the relationship identification system 216 expands the search query to include the second target entity based on the database modification operation. At operation 1030, the relationship identification system 216 performs a search of the database of the online service using the expanded search query. At operation 1040, the relationship identification system 216 generates search results based on the performing of the search using the expanded search query. At operation 1050, the relationship identification system 216 causes the search results to be displayed on the computing device.

It is contemplated that any of the other features described within the present disclosure can be incorporated into the method 1000.

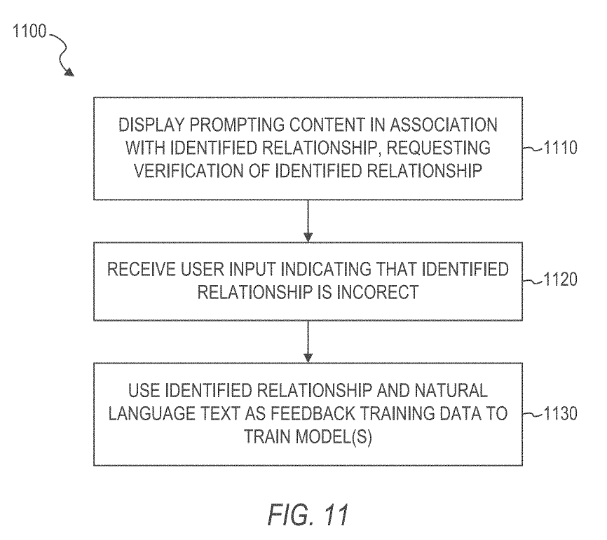

FIG. 11 is a flowchart illustrating another method of performing a relationship verification operation, in accordance with an example embodiment. The method 1100 can be performed by processing logic that can comprise hardware (e.g., circuitry, dedicated logic, programmable logic, microcode, etc.), software (e.g., instructions run on a processing device), or a combination thereof. In one implementation, the method 1100 is performed by the relationship identification system 216 of FIGS. 2-3, or any combination of one or more of its modules, as described above.

At operation 1110, the relationship identification system 216 causes a prompting content to be displayed on the computing device in association with the identified relationship. In some example embodiments, the prompting content comprises a request that a user of the computing device verify the identified relationship.

At operation 1120, the relationship identification system 216 receives a user input from the computing device. In some example embodiments, the user input comprises an indication that the identified relationship is incorrect.

At operation 1130, the relationship identification system 216 uses the identified relationship between the first target entity and the second target entity and the natural language text as feedback training data to train the model(s). In some example embodiments, the feedback training data is tagged or labelled as an example of an incorrectly identified relationship.

It is contemplated that any of the other features described within the present disclosure can be incorporated into the method 1100.

### Example Mobile Device

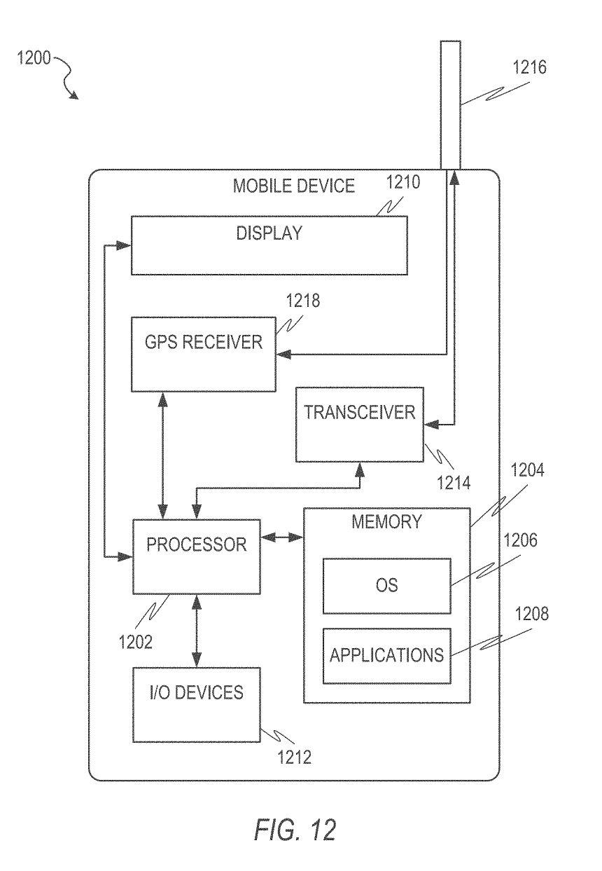

FIG. 12 is a block diagram illustrating a mobile device 1200, according to an example embodiment. The mobile device 1200 can include a processor 1202. The processor 1202 can be any of a variety of different types of commercially available processors suitable for mobile devices 1200 (for example, an XScale architecture microprocessor, a Microprocessor without interlocked Pipeline Stages (MIPS) architecture processor, or another type of processor). A memory 1204, such as a random access memory (RAM), a Flash memory, or other type of memory, is typically accessible to the processor 1202. The memory 1204 can be adapted to store an operating system (OS) 1206, as well as application programs 1208, such as a mobile location-enabled application that can provide location-based services (LBSs) to a user. The processor 1202 can be coupled, either directly or via appropriate intermediary hardware, to a display 1210 and to one or more input/output (I/O) devices 1212, such as a keypad, a touch panel sensor, a microphone, and the like. Similarly, in some embodiments, the processor 1202 can be coupled to a transceiver 1214 that interfaces with an antenna 1216. The transceiver 1214 can be configured to both transmit and receive cellular network signals, wireless data signals, or other types of signals via the antenna 1216, depending on the nature of the mobile device 1200. Further, in some configurations, a GPS receiver 1218 can also make use of the antenna 1216 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine Readable Medium

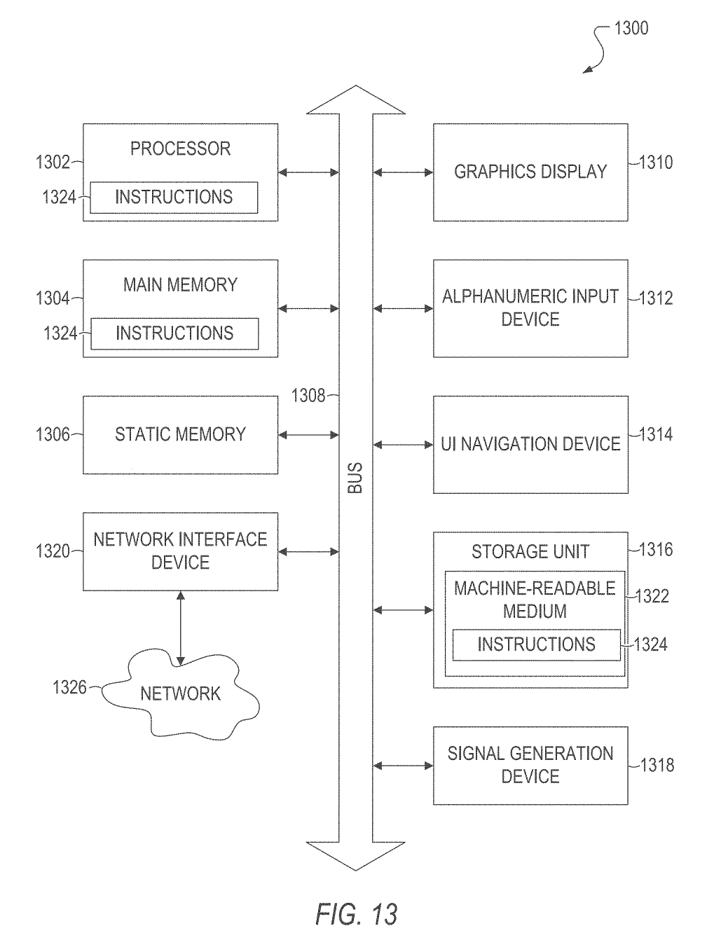

FIG. 13 is a block diagram of an example computer system 1300 on which methodologies described herein may be executed, in accordance with an example embodiment. In alternative embodiments, the machine operates as a standalone device or may be connected (e.g., networked) to other machines, in a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU) or both), a main memory 1304 and a static memory 1306, which communicate with each other via a bus 1308. The computer system 1300 may further include a graphics display unit 1310 (e.g., a liquid crystal display (LCD) or a cathode ray tube (CRT)). The computer system 1300 also includes art alphanumeric input device 1312 (e.g., a keyboard or a touch-sensitive display screen), a user interface (UI) navigation device 1314 (e.g., a mouse), a storage unit 1316, a signal generation device 1318 (e.g., a speaker) and a network interface device 1320.

### Machine-Readable Medium

The storage unit 1316 includes a machine-readable medium 1322 on which is stored one or more sets of instructions and data structures (e.g., software) 1324 embodying or utilized by any one or more of the methodologies or functions described herein. The instructions 1324 may also reside, completely or at least partially, within the main memory 1304 and/or within the processor 1302 during execution thereof by the computer system 1300, the main memory 1304 and the processor 1302 also constituting machine-readable media.

While the machine-readable medium 1322 is shown in an example embodiment to be a single medium, the term “machine-readable medium” may include a single medium or multiple media (e.g., a centralized or distributed database, and/or associated caches and servers) that store the one or more instructions 1324 or data structures. The term “machine-readable medium” shall also be taken to include any tangible medium that is capable of storing, encoding or carrying instructions (e.g., instructions 1324) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1324 may further be transmitted or received over a communications network 1326 using a transmission medium. The instructions 1324 may be transmitted using the network interface device 1320 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
accessing, by a computer system having at least one hardware processor, corresponding profile data from each one of a plurality of profiles stored in a database of an online service;
extracting, by the computer system, a plurality of training entity pairs from the profile data of the plurality of profiles based on a matching of at least one regular expression with the profile data, each one of the plurality of training entity pairs comprising a first training entity and a second training entity;
training, by the computer system, at least one model using the plurality of training entity pairs as training data;
ingesting, by a computer system, natural language text comprising a first target entity and a second target entity;
identifying, by the computer system, a relationship between the first target entity and the second target entity using the at least one model; and
performing, by the computer system, a function using the identified relationship between the first target entity and the second target entity based on the identifying of the relationship, the function comprising a database modification operation or a relationship verification operation, the database modification operation comprising modifying at least one of a graph, a corresponding profile of the first target entity, and a corresponding profile of the second target entity stored in the database of the online service to indicate the identified relationship, and the relationship verification operation comprising causing the identified relationship to be displayed on a computing device.

2. The computer-implemented method of claim 1, wherein the at least one model comprises a first model and a second model, and the training of the at least one model comprises:
training the first model to generate a probability that there is a relationship between two given entities; and
training the second model to generate a probability that the relationship comprises a particular type of relationship between the two given entities.

3. The computer-implemented method of claim 1, wherein the training of the at least one model comprises training the at least one model using the plurality of training entity pairs and other natural language text.

4. The computer-implemented method of claim 1, wherein the identifying the relationship between the first target entity and the second target entity comprises generating a probability that the identified relationship exists between the first target entity and the second target entity.

5. The computer-implemented method of claim 4, wherein the performing the function comprises performing the database modification operation based on a determination that the probability exceeds a predetermined threshold value.

6. The computer-implemented method of claim 4, wherein the performing the function comprises performing the relationship verification operation, the relationship verification operation further comprising causing the probability to be displayed on the computing device in association with the identified relationship.

7. The computer-implemented method of claim 1, wherein the at least one model comprises at least one logistic regression model.

8. The computer-implemented method of claim 1, wherein the at least one model comprises at least one binary classification model.

9. The computer-implemented method of claim 1, wherein the natural language text is ingested from target profile data of a target profile stored in the database of the online service.

10. The computer-implemented method of claim 9, wherein the natural language text is ingested from a work experience field of the target profile data.

11. The computer-implemented method of claim 1, wherein the natural language text is ingested from an article or blog post published online.

12. The computer-implemented method of claim 1, wherein the identifying of the relationship comprises identifying a direction of the relationship, the direction indicating a hierarchy among the first target entity and the second target entity.

13. The computer-implemented method of claim 1, wherein the performing the function comprises performing the database modification operation in response to the identifying of the relationship.

14. The computer-implemented method of claim 1, wherein the performing the function comprises performing the relationship verification operation, the relationship verification operation further comprising:
causing a prompting content to be displayed on the computing device in association with the identified relationship, the prompting content requesting that a user of the computing device verify the identified relationship;
receiving a user input from the computing device, the user input indicating that the identified relationship is correct; and
performing the database modification operation based on the user input indicating that the identified relationship is correct.

15. The computer-implemented method of claim 1, further comprising:
receiving a search query comprising the first target entity from a computing device;
expanding the search query to include the second target entity based on the database modification operation;
performing a search of the database of the online service using the expanded search query;
generating search results based on the performing of the search using the expanded search query; and
causing the search results to be displayed on the computing device.

16. The computer-implemented method of claim 1, wherein the performing the function comprises performing the relationship verification operation, the relationship verification operation further comprising:
causing a prompting content to be displayed on the computing device in association with the identified relationship, the prompting content requesting that a user of the computing device verify the identified relationship;
receiving a user input from the computing device, the user input indicating that the identified relationship is incorrect; and
using the identified relationship between the first target entity and the second target entity and the natural language text as feedback training data to train the at least one model, the feedback training data being tagged as an example of an incorrectly identified relationship.

17. The computer-implemented method of claim 1, wherein the first training entity, the second training entity, the first target entity, and the second target entity each comprise a corresponding organization.

18. The computer-implemented method of claim 1, wherein each one of the plurality of training entity pairs is extracted from a corresponding work experience field of the corresponding profile data.

19. A system comprising:
at least one hardware processor; and
a non-transitory machine-readable medium embodying a set of instructions that; when executed by the at least one hardware processor, cause the at least one processor to perform operations, the operations comprising:
accessing corresponding profile data from each one of a plurality of profiles stored in a database of an online service;
extracting a plurality of training entity pairs from the profile data of the plurality of profiles based on a matching of at least one regular expression with the profile data, each one of the plurality of training entity pairs comprising a first training entity and a second training entity;
training at least one model using the plurality of training entity pairs as training data;
receiving natural language text comprising a first target entity and a second target entity;
identifying a relationship between the first target entity and the second target entity using the at least one model; and
performing a function using the identified relationship between the first target entity and the second target entity based on the identifying of the relationship.

20. A non-transitory machine-readable medium embodying a set of instructions that, when executed by at least one hardware processor, cause the processor to perform operations, the operations comprising:
ingesting natural language text comprising a first target entity and a second target entity;
identifying a relationship between the first target entity and the second target entity using at least one model; and
performing a function using the identified relationship between the first target entity and the second target entity based on the identifying of the relationship, the function comprising a database modification operation or a relationship verification operation, the database modification operation comprising modifying at least one of a graph, a corresponding profile of the first target entity, and a corresponding profile of the second target entity stored in the database of the online service to indicate the identified relationship, and the relationship verification operation comprising causing the identified relationship to be displayed on a computing device.
